(19) United States
(12) Patent Application Publication
(10) Pub. No.: US 2008/0284938 A1
(43) Pub. Date: Nov. 20, 2008

(54) IMAGE DISPLAY APPARATUS

(75) Inventors: Koji Ichikawa, Kumamoto (JP); Toyohito Hatashita, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/122,076

(22) Filed: May 16, 2008

(30) Foreign Application Priority Data
May 18, 2007 (JP) 2007-132350

(51) Int. Cl. G02F 1/1333

(52) U.S. Cl. 349/58

(57) ABSTRACT

The present invention relates to image display apparatuses that use a backlight source. An object of the invention is to provide an image display apparatus including an extra-length absorbing portion that improves the degree of flexibility in routing a lamp cable, which is a power supply path to a light source, and having a high degree of flexibility regarding the position for placing the power supply source. An image display apparatus of the present invention includes an image display panel, a backlight source of the image display panel, a lamp cable which is a power supply path to the light source, and an extra-length absorbing portion that absorbs an extra length of the lamp cable. The extra-length absorbing portion includes a protrusion disposed on a back surface or a side surface of the image display apparatus.

### BACKGROUND OF THE INVENTION

1. Field of the Invention

The present invention relates to image display apparatuses that use a backlight source, and more particularly relates to techniques of improving the degree of flexibility in routing a lamp cable which is a power supply path to a light source.

2. Description of the Background Art

Japanese Patent Application Laid-Open No. 08-29782 proposes a liquid crystal display (hereinafter referred to as an “LCD”) apparatus that uses a reel having the center of rotation at a position other than the center of the reel, as an extra-length absorbing portion that absorbs an extra length of a lamp cable.

A reel having the center of rotation at a position other than the center of the reel is used as an extra-length absorbing portion for use in an LCD apparatus disclosed in Japanese Patent Application Laid-Open No. 08-29782. However, such a structure imposes restrictions on a position for placing a power supply source including an inverter and a driver. Thus, there has been a problem that the position for placing a power supply source has a low degree of flexibility.

### SUMMARY OF THE INVENTION

An object of the present invention is to provide an image display apparatus having an extra-length absorbing portion for a lamp cable with a high degree of flexibility regarding the position for placing a power supply source.

An image display apparatus according to an aspect of the invention includes an image display panel, a backlight source of the image display panel, a lamp cable, and an extra-length absorbing portion. The lamp cable is a power supply path to the light source. The extra-length absorbing portion absorbs an extra length of the lamp cable. The extra-length absorbing portion has a protrusion disposed on at least one of a back surface and a side surface of the image display apparatus.

This image display apparatus has an extra-length absorbing portion, which absorbs the extra length of a lamp cable, including a protrusion disposed on a back surface or a side surface of the image display apparatus. Therefore, a power supply source can be freely placed within the reach of the lamp cable.

An image display apparatus according to another aspect of the invention includes an image display panel, a backlight source of the image display panel, a lamp cable, and an extra-length absorbing portion. The lamp cable is a power supply path to the light source. The extra-length absorbing portion absorbs an extra length of the lamp cable. The extra-length absorbing portion has an elastic structure of the lamp cable.

An elastic lamp cable is used, and therefore the effective lamp cable length can be adjusted without placing a protrusion in the image display apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 illustrate an LCD apparatus according to a first embodiment of the present invention;

FIG. 3 illustrates an LCD apparatus according to a second embodiment of the present invention;

FIG. 4 illustrates an LCD apparatus according to a third embodiment of the present invention;

FIG. 5 illustrates an LCD apparatus according to a fourth embodiment of the present invention;

FIGS. 6 and 7 illustrate a component according to the fourth embodiment of the present invention;

FIG. 8 illustrates an LCD apparatus according to a fifth embodiment of the present invention; and

FIGS. 9 to 17 illustrate components according to the first embodiment of the present invention.

### DESCRIPTION OF THE PREFERRED EMBODIMENTS

The present invention will be described in detail below with reference to the drawings showing embodiments.

### First Embodiment

### (Structure)

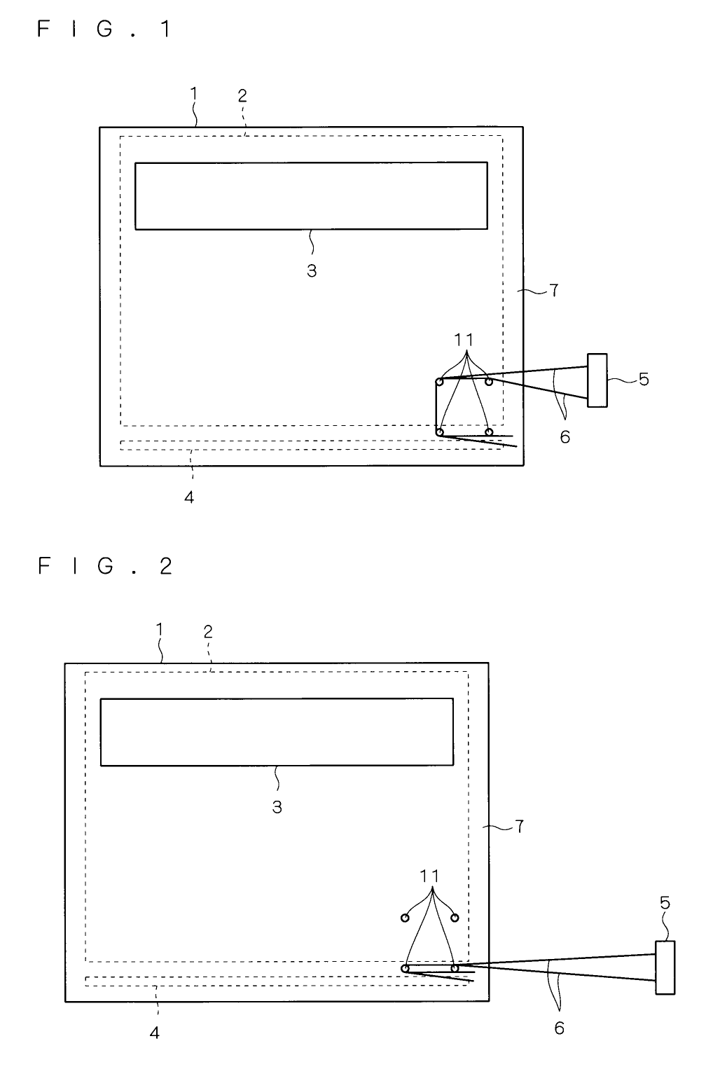

FIGS. 1 and 2 show an LCD apparatus 1 according to the present embodiment as seen from its non-display surface (back surface). Inside a frame 7 made of resin, metal, or the like, an LCD panel 2 and a fluorescent tube (backlight source) 4 are incorporated. First ends of lamp cables 6 are connected to the fluorescent tube 4, and second ends are connected to a lamp connector 5. On a surface of the frame 7, a control substrate 3 for controlling the LCD panel 2 is provided. In a bottom right portion of the frame 7, four protrusions 11 for winding the lamp cables 6 are disposed as extra-length absorbing portions for the lamp cables 6. The number of protrusions 11 is not limited to four. The protrusions 11 are not limited to being placed on a back surface of the LCD apparatus 1, but may be disposed on a side surface. The protrusions 11 may be built in the frame 7 when the frame 7 is formed. It may also be designed such that holes for attachment are formed and thereafter the protrusions are attached.

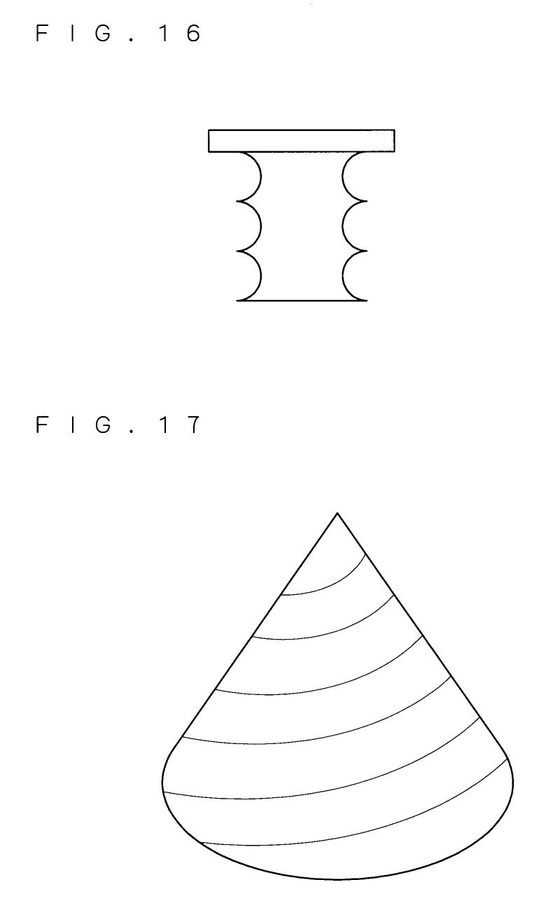

Next, shape examples of the protrusion 11 are shown in FIGS. 9 to 17.

The shape in FIG. 9 is a rectangular parallelepiped, and the shape in FIG. 10 is cylindrical. Simple shapes like these ones are acceptable.

The protrusions 11 in FIGS. 11 to 15 are shaped to prevent the lamp cable 6 from being removed from the protrusion 11.

FIG. 11 shows a protrusion with an upper portion in a hooked shape, which allows the lamp cable 6 to be caught.

FIG. 12 shows a protrusion with an upper portion in a hooked shape including a U-shape that can catch and hold the lamp cable 6. Making a space width 8 slightly smaller than the diameter of the lamp cable 6 causes the shape to catch the lamp cable 6 to prevent the lamp cable 6 from being removed.

FIG. 13 shows a cylindrical shape with an end whose diameter is larger than that of the other portion. This shape allows the lamp cable 6 to be caught.

In FIG. 14, protrusions each having a hooked upper portion shown in FIG. 11 face each other. This shape allows the lamp cable 6 to be inserted from a space between two protrusions, thereby preventing the lamp cable 6 from being removed.

FIG. 15 shows a protrusion that is an opening/closing type and has a groove formed therein for holding the lamp cable 6 when closing. In this shape, closing prevents the lamp cable 6 from being removed.

An effective lamp cable length can be adjusted by changing the size of the protrusion 11, e.g., the diameter of a cylindrical shape shown in FIG. 10. The effective lamp cable length can also be adjusted by changing the number of turns of the lamp cable 6 around the protrusion 11.

At this point, the structure may be made such that grooves as shown in FIG. 16 are formed in the protrusion 11 to ensure the winding of the lamp cable. Alternatively, using a conical shape having grooves along which the lamp cable is wound as shown in FIG. 17, the effective lamp cable length can also be adjusted by adjusting the position of winding and the number of turns of the lamp cable.

Protrusions of these shapes may be combined.

### (Operations)

When the lamp connector 5 is connected to a power supply source, the lamp cables 6 are made to pass through the protrusions 11.

For example, as shown in FIG. 1, the lamp cables 6 pass through four protrusions 11 and are connected to the power supply source on a system side.

As shown in FIG. 2, the lamp cables 6 can pass through two protrusions 11 to be connected to the power supply source on the system side. In this way, the number of protrusions 11 through which the lamp cables pass is reduced, thereby enabling the effective lamp cable length from the LCD apparatus 1 to be made larger than that in the case shown in FIG. 1.

### (Effects)

By forming the protrusions 11, the lamp cables 6 can be connected to the power supply source on the system side through the protrusions 11, thereby enabling the extra length of the lamp cables 6 to be absorbed.

Changing the size and number of the protrusions 11 through which the lamp cables pass and changing the number of turns of the lamp cables enable adjustment of the effective lamp cable length. This adjustment allows the power supply source to be freely placed within the reach of the lamp cables 6.

### Second Embodiment

### (Structure)

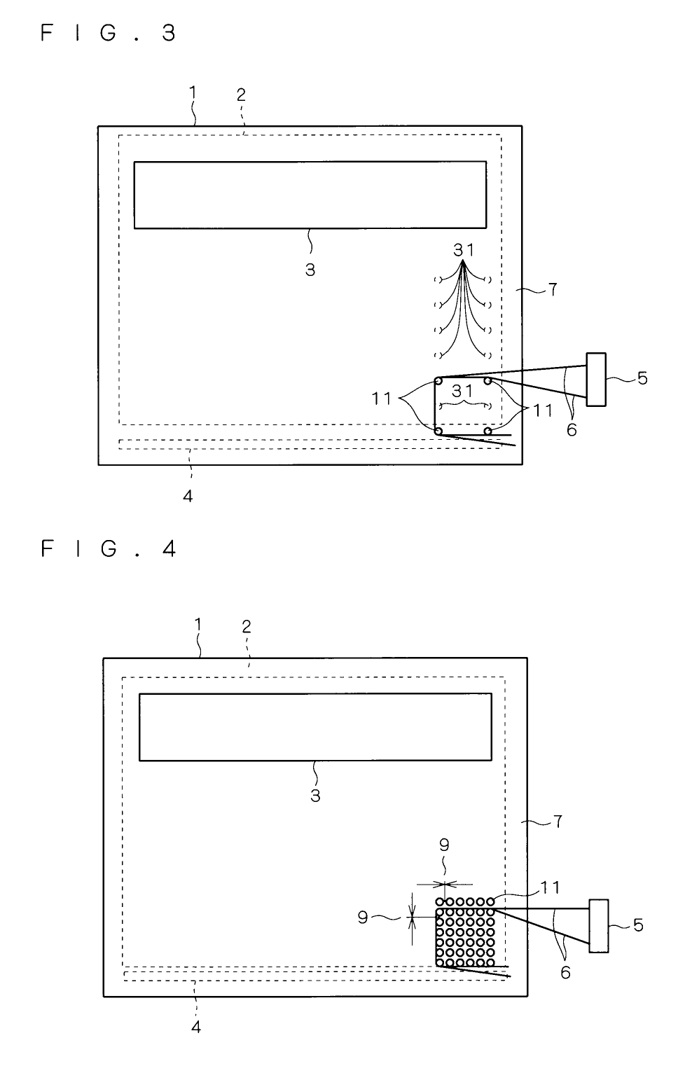

FIG. 3 shows the LCD apparatus 1 according to the present embodiment as seen from its non-display surface. In a bottom right portion of the frame 7, four protrusions 11 for winding the lamp cables 6 are disposed as extra-length absorbing portions for the lamp cables 6. Further in the present embodiment, ten attachment holes 31 for disposing the protrusions 11 to be fit thereinto are formed in a right portion of the frame 7.

Other structures are the same as in the first embodiment, and therefore detailed description thereof is not given here.

### (Operations)

In the same manner as in the first embodiment, the lamp cables 6 are made to pass through the protrusions 11 when the lamp connector 5 is connected to a power supply source.

When needed, the protrusions 11 are disposed to be fitted into the attachment holes 31, the number of the protrusions 11 is changed, and the shape in which the lamp cables 6 pass is also changed in accordance with the change.

Regarding methods for attaching the protrusions 11, an adhesive sheet or an adhesive agent, instead of the attachment holes 31, may be used such that the protrusions 11 are disposed to be adhesively bonded to the frame 7. Some of the methods may be combined.

### (Effects)

Forming the attachment holes 31 in the frame 7 allows changes of the positions for attaching the protrusions 11 and the number of the protrusions 11. This allows finer adjustment of the effective lamp cable length.

### Third Embodiment

### (Structure)

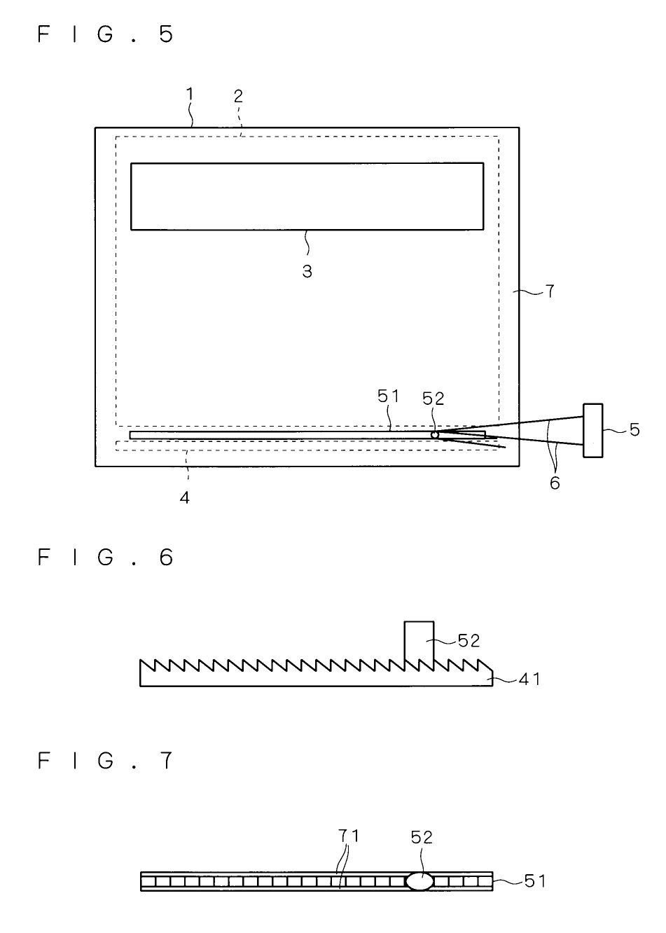

FIG. 4 shows an LCD apparatus 1 according to the present embodiment as seen from its non-display surface. In a bottom right portion of the frame 7, a plurality of protrusions 11 for winding the lamp cables 6 are disposed as extra-length absorbing portions for the lamp cables 6. A space width 9 of the protrusions 11 is formed to be slightly smaller than the diameter of the lamp cable 6, and the protrusions 11 are disposed adjacent to one another so as to be able to catch and hold the lamp cables 6.

Other structures are the same as in the first embodiment, and therefore detailed description thereof is not given here.

### (Operations)

In the same manner as in the first embodiment, the lamp cables 6 are made to pass through the protrusions 11 when the lamp connector 5 is connected to a power supply source. At this point, the lamp cables 6 are caught between the protrusions 11 so that the lamp cables 6 are fixed.

### (Effects)

The lamp cables 6 can be caught between the protrusions 11. This can ensure that the lamp cables 6 are fixed.

A plurality of protrusions 11 are provided, and therefore fine adjustment of the effective lamp cable length can be performed without adding the protrusion 11.

### Fourth Embodiment

### (Structure)

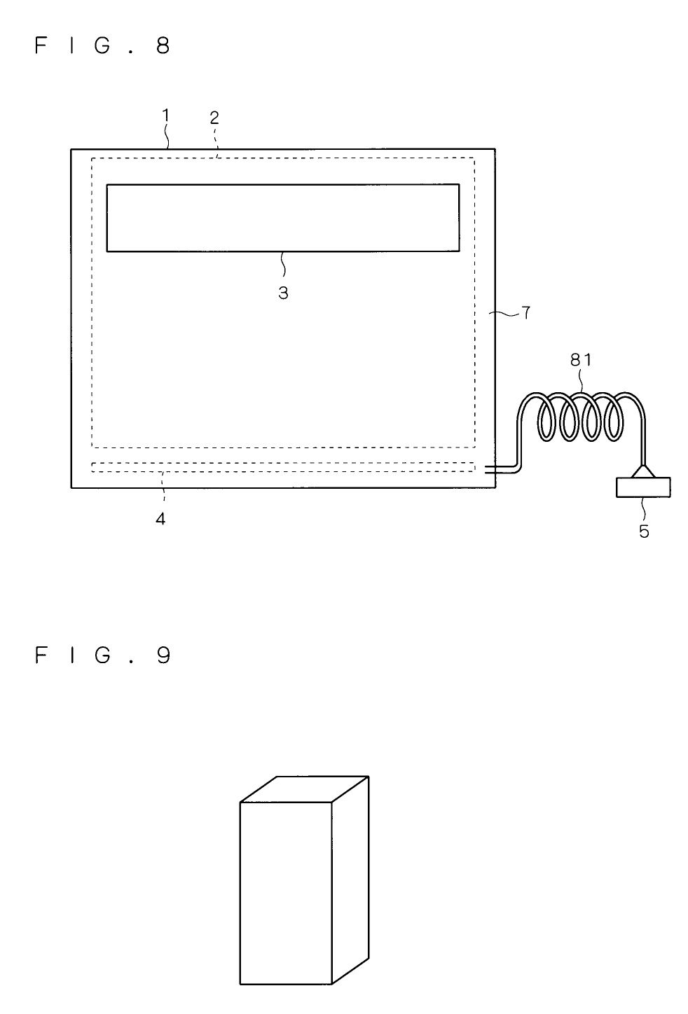

FIG. 5 shows an LCD apparatus 1 according to the present embodiment as seen from its non-display surface. In a bottom portion of the frame 7, a protrusion 52 for winding the lamp cables 6 is disposed as an extra-length absorbing portion for the lamp cables 6. In a portion for placing the protrusion 52 in the frame 7, a groove 51 that can cause the protrusion 52 to move in a lateral direction is formed.

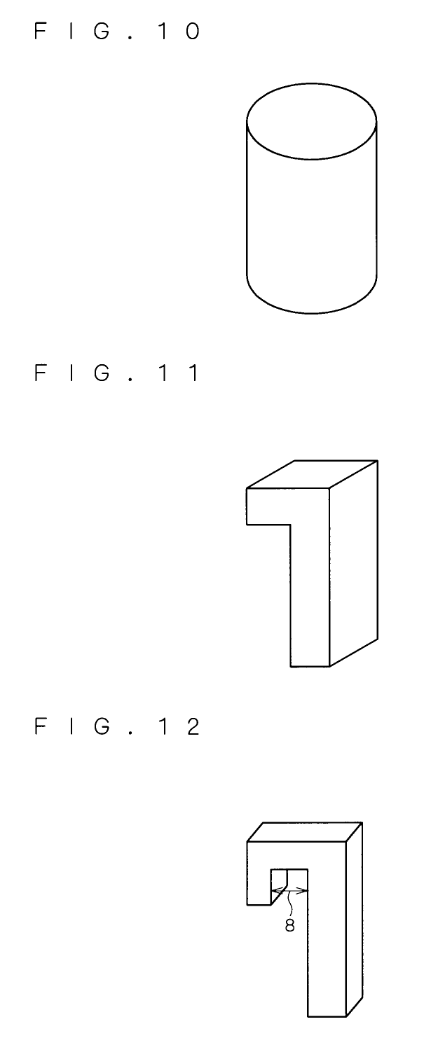

FIG. 6 shows a side view of a portion where the groove 51 is formed, and FIG. 7 shows a top view of the portion. As shown in FIG. 6, projections and depressions are formed on the surface of a groove base 41 and a bottom portion of the protrusion 52, constituting a ratchet structure. That is, the protrusion 52 has a structure in which the protrusion 52 can be moved in right and left directions along guides (groove side surfaces) 71 shown in FIG. 7, and in which a fixed state of the protrusion 52 can be kept even if force in a right direction is applied.

While only one groove 51 is provided in FIGS. 5 to 7, a plurality of grooves may be provided.

Other structures are the same as in the first embodiment, and therefore detailed description thereof is not given here.

### (Operations)

In the same manner as in the first embodiment, the lamp cables 6 are made to pass through the protrusion 52 when the lamp connector 5 is connected to the power supply source.

When needed, the protrusion 52 is moved, and the length for the lamp cables 6 passing through the protrusion 52 is also changed in accordance with the movement.

### (Effects)

The protrusion 52 can be moved, and therefore the effective lamp cable length can be adjusted without placing a plurality of protrusions.

This structure may be used in combinations with structures shown in other embodiments.

### Fifth Embodiment

### (Structure)

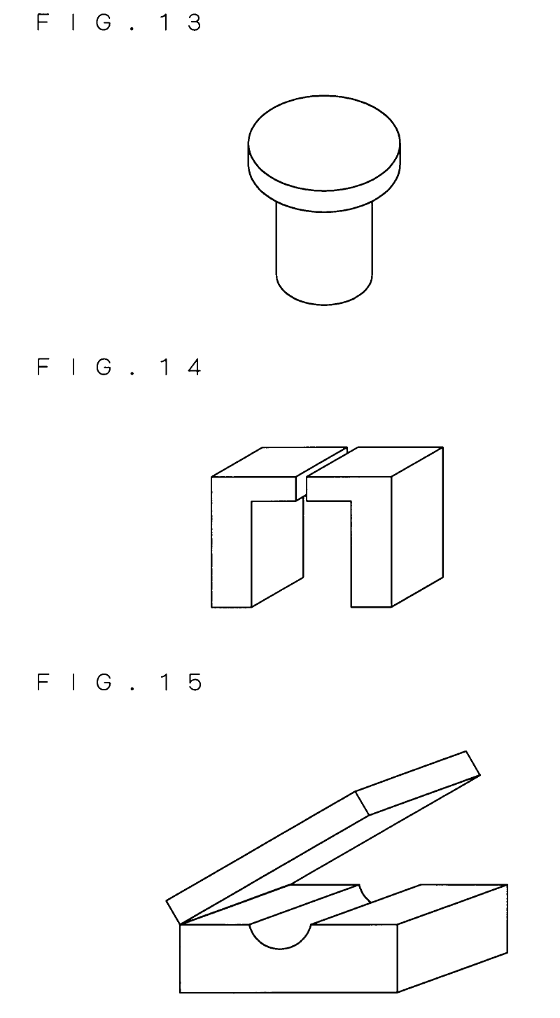

FIG. 8 shows an LCD apparatus 1 according to the present embodiment as seen from its non-display surface. Unlike other embodiments, no protrusion is formed in the frame 7 in the present embodiment. A curled cord having an elastic structure is used as a lamp cable 81.

Other structures are the same as in the first embodiment, and therefore detailed description thereof is not given here.

### (Operations)

When the lamp connector 5 is connected to a power supply source, the lamp cable 81 is expanded or contracted to the distance of which the lamp cable 81 is routed.

### (Effects)

An elastic curled cord is used as the lamp cable 81, and therefore the effective lamp cable length can be adjusted without placing a protrusion in the frame 7.

While the invention has been shown and described in detail, the foregoing description is in all aspects illustrative and not restrictive. It is therefore understood that numerous modifications and variations can be devised without departing from the scope of the invention.

1. An image display apparatus comprising:
an image display panel;
a backlight source of said image display panel;
a lamp cable which is a power supply path to said light source; and
an extra-length absorbing portion that absorbs an extra length of said lamp cable;
said extra-length absorbing portion including a protrusion disposed on at least one of a back surface and a side surface of said image display apparatus;
said protrusion having an upper portion formed in a hooked shape.

2. The image display apparatus according to claim 1, wherein said hooked shape includes a U shape that can catch and hold said lamp cable in a space thereof.

3. The image display apparatus according to claim 1, wherein said protrusion includes a plurality of protrusions including protrusions adjacent to each other that can catch and hold said lamp cable in a space therebetween.

4. The image display apparatus according to claim 1, wherein said protrusion is disposed to be fixed into an attachment hole provided in said image display apparatus.

5. The image display apparatus according to claim 1, wherein said protrusion is disposed to be adhesively bonded to said image display apparatus.

6. The image display apparatus according to claim 1 wherein said protrusion is disposed to be movable.

7. The image display apparatus comprising:
an image display panel;
a backlight source of said image display panel;
a lamp cable that is a power supply path to said light source; and
an extra-length absorbing portion that absorbs an extra length of said lamp cable;
said extra-length absorbing portion including an elastic structure of said lamp cable.

8. The image display apparatus according to claim 1, wherein said image display panel is a liquid crystal display panel.

9-10. (canceled)
